(19) United States
(12) Patent Application Publication
(10) Pub. No.: US 2002/0052276 A1
(43) Pub. Date: May 2, 2002

(54) Method for making gift-wrap tissue paper

(76) Inventor: Steve Pensak, Fairfield, CT (US)

Correspondence Address: Liniak, Berenato, Longacre & White, Suite 240, 6550 Rock Spring Drive, Bethesda, MD, 20817, US

(21) Appl. No.: 09/750,681

(22) Filed: Jan. 2, 2001

Related U.S. Application Data
(60) Provisional application No. 60/179,137, filed on Jan. 31, 2000.

(51) Int. Cl. D06P 7/00; B31B 1/88

(52) U.S. Cl. 493/187; 428/542.2; 87/1

(57) ABSTRACT

A novel gift-wrap tissue paper and a method for making thereof are disclosed. The gift-wrap tissue paper has a generally rectangular shape, and is provided with a plurality of continuous, preferably interconnected ornamental figures, such as Christmas trees or the like, imprinted along edges thereof. The gift-wrap tissue paper has a continuous nonlinear outer peripheral edge that substantially coincides with a continuous outer contour line formed by interconnecting outermost edges of the ornamental figures. The method for making the gift-wrap tissue paper includes the steps of imprinting the continuous series of ornamental figures on a plurality of blank sheets forming a decorative border, stacking the imprinted blank sheets, die-cutting the stack of the imprinted blank sheets with a cutting die having a cutting edge complimentary to the continuous outer contour line of the decorative border, and separating the gift-wrap tissue papers.

### CROSS-REFERENCE TO RELATED APPLICATION

This Application claims the benefit under 35 U.S.C. 119(e) of U.S. Provisional Application No. 60/179,137 filed Jan. 31, 2000 by Steve Pensak.

### BACKGROUND OF THE INVENTION

1. Field of the Invention

The present invention relates broadly to gift-wrap tissue papers and, more particularly, to a method for making gift-wrap tissue papers having an decorative border and a decorative nonlinear outer contour line.

2. Description of the Prior Art

Gift giving is a very popular tradition employed for many special occasions. Most people, at one time or another, have given a gift to someone else. A wide variety of gift-wrapping and packaging materials is available to a gift giver. Separate gift-wrap tissue paper is conventionally used to adorn a gift before placing it in a gift box.

Currently, the gift-wrap tissue paper is commercially available in the form of a rectangular plain sheet of the tissue paper.

Therefore, there is a need for the gift-wrap tissue paper, which is ornamentally enhanced and aesthetically pleasing.

### SUMMARY OF THE INVENTION

The present invention is an improvement over the gift-wrap tissue paper of the prior art.

It is therefore an object of the present invention to provide for a novel and improved gift-wrap tissue paper and a method for making thereof.

In accordance with the present invention, the gift-wrap tissue paper has a generally rectangular shape, and is provided with a plurality of continuous, preferably interconnected ornamental figures, such as Christmas trees or the like, imprinted along edges thereof forming a decorative border. Each of the ornamental figures has an outer edge. The gift-wrap paper has a continuous non-linear outer peripheral edge that substantially coincides with a continuous outer contour line formed by interconnecting the outermost edges of the ornamental figures.

The method for making gift-wrap tissue paper of the present invention includes the steps of:

providing a plurality of blank sheets of a tissue paper;

printing on at least one side surface of the blank sheets a continuous series of ornamental figures forming a plurality of imprinted blank sheets, the continuous series of ornamental figures defines a decorative border of the gift-wrap paper, the decorative border has a continuous outer contour line formed by outer edges of said ornamental figures;

stacking said plurality of imprinted blank sheets of lightweight sheet material into a first stack;

providing a cutting die having a cavity defined by a continuous cutting edge, wherein a contour of said cutting edge is substantially complimentary to the outer contour line of the decorative border;

placing the cutting die onto the first stack so that the cutting edge thereof is substantially aligned with the outer contour line of the decorative border;

applying sufficient force to the cutting die to cut the first stack along the outer contour line of the decorative border to form a second stack of the gift-wrap papers; and

separating the gift-wrap papers of the second stack from each other.

### BRIEF DESCRIPTION OF THE DRAWINGS

Other objects and advantages of the invention will become apparent from a study of the following specification when viewed in light of the accompanying drawings, wherein:

FIG. 1A is a top plan view of a gift-wrap paper in accordance with the present invention;

FIG. 1B is a top plan view of an alternative embodiment of the gift-wrap paper in accordance with the present invention;

FIG. 2 is a block diagram of a method for making the gift-wrap paper in accordance with the present invention;

FIG. 3 is a top plan view of a blank sheet with an imprinted decorative border;

FIG. 4 is a perspective view on a cutting die in accordance with the present invention;

FIG. 5 is a front elevational view of a press for practicing the method of making the gift-wrap paper in accordance with the present invention;

FIG. 6 is a side elevational view of a press for practicing the method of making the gift-wrap paper in accordance with the present invention.

### DETAILED DESCRIPTION OF PREFERRED EMBODIMENTS

The preferred embodiments of the present invention will now be described with the reference to accompanying drawings.

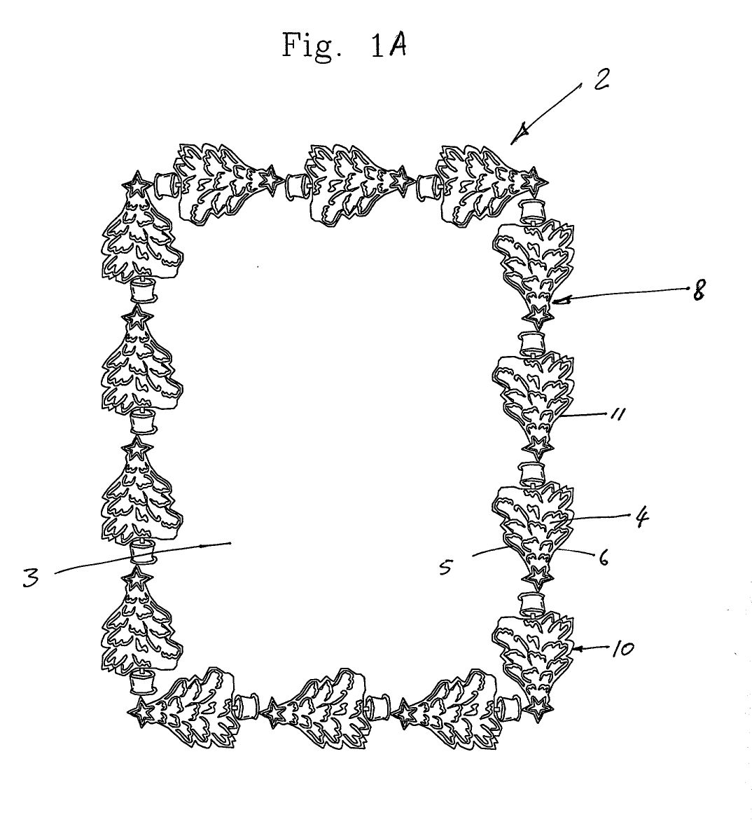

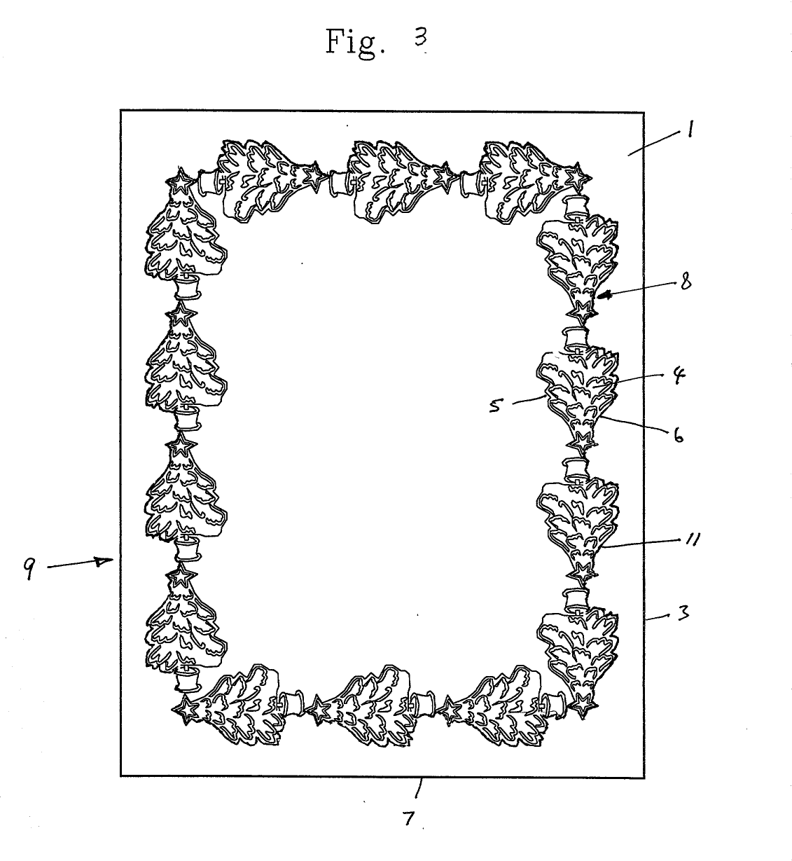

The present invention is related to a method for making a novel gift-wrap paper. The novel gift-wrap paper 2 illustrated in FIG. 1A, includes a sheet 3 having a generally rectangular shape, and is provided with a plurality of continuous, preferably interconnected ornamental FIGS. 4 imprinted on the sheet 3 along edges thereof forming a decorative border 8. Each of the ornamental FIGS. 4 has an inner edge 5 and an outer edge 6. The gift-wrap paper 2 has a continuous nonlinear outer peripheral edge 10 that substantially coincides with a continuous outer contour line 11 of the decorative border 8 formed by interconnecting the outermost edges 6 of the ornamental FIGS. 4.

Alternatively, only a portion of the outer peripheral edge 10 coincides with the outer contour line 11 of the decorative border 8. As illustrated in FIG. 1B, the continuous outer peripheral edge 10 includes a pair of opposite non-linear peripheral side edges 10′ and a pair of opposite linear peripheral top and bottom edges 10″.

In the first embodiment of the present invention, the decorative border 8 is imprinted only on one side of the gift-wrap paper 2. In the second embodiment of the present invention, the decorative border 8 is imprinted on both sides of the gift-wrap paper 2.

In the exemplary embodiment shown in FIG. 1, the ornamental FIGS. 4 are Christmas trees. It will be appreciated that any other appropriate ornamental figures or themes, such as Christmas decorations, bears, hearts, flowers, leaves, etc., are within the scope of the present invention. The decorative border 8 may include a plurality of identical ornamental figures, or, alternatively, a plurality of different ornamental figures. Preferably, the ornamental FIGS. 4 are multicolored.

Moreover, in the exemplary embodiment shown in FIG. 1, the decorative border 8 is generally rectangular in shape. It will be appreciated that any other appropriate shapes, such as circular, diamond, triangular, etc., are within the scope of the present invention.

The gift-wrap paper 2 is made of an appropriate lightweight material conventionally used for making the gift-wrap papers. Preferably, gift-wrap paper 2 of the present invention is made of a tissue paper. It will be appreciated that other appropriate lightweight materials adapted to be used as the gift-wrap paper, such as vinyl film, are within the scope of the present invention.

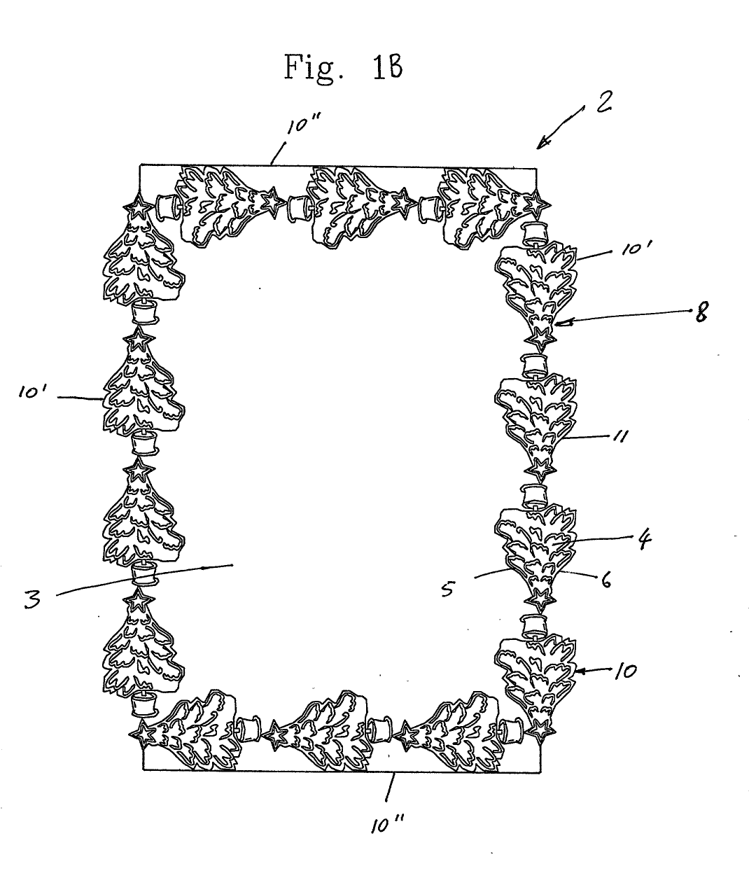

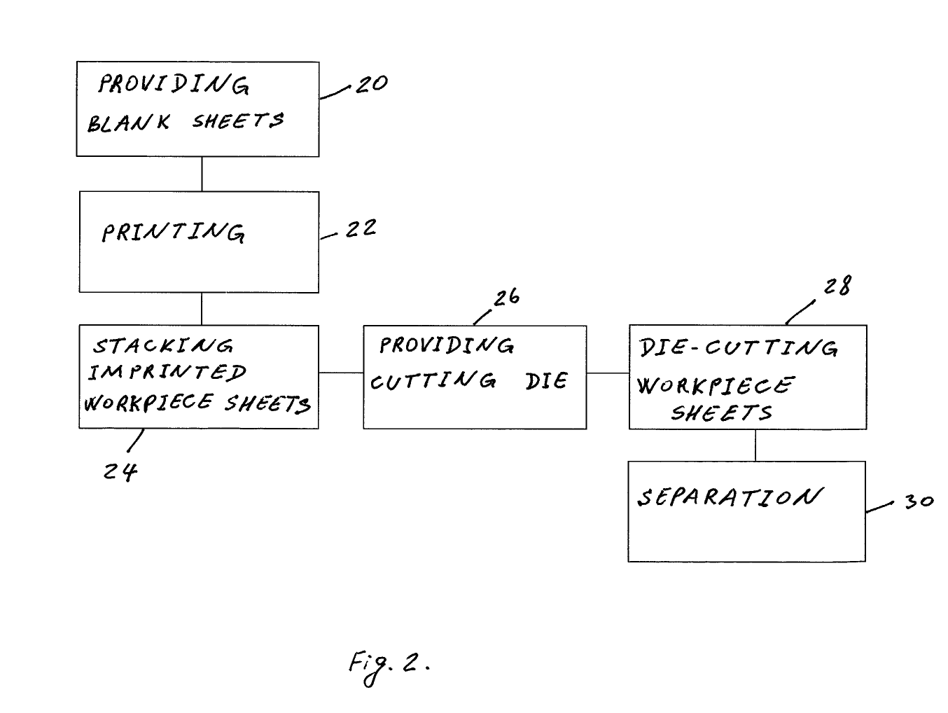

Reference is now made to FIGS. 2 wherein there is disclosed the method for making the gift-wrap paper 2 in accordance with the present invention. In the first step 20, a plurality of blank sheets 1 of the tissue paper, illustrated in FIG. 3, is provided. Preferably, the blank sheets 1 are cut from a rolled stock tissue paper into sheets of about 20″×26″.

The second step 22 is color printing on each of the blank sheets 1 the decorative border 8 in the form of the plurality of the continuous, preferably interconnected ornamental FIGS. 4 adjacent to side edges 7 of the blank sheet 1, thus forming a plurality of imprinted blank sheets 9 as illustrated in FIG. 3. The particular type of a printing apparatus employed in this method is not of the essence of the present invention and does not require detailed description.

In the first embodiment of the present invention, the decorative border 8 is imprinted only on one side of the blank sheets 1. In the second embodiment of the present invention, the decorative border 8 is imprinted on both sides of the blank sheets 1 so that the outer contour lines printed on the opposite sides of the blank sheets 1 are aligned with respect to each other.

Next step 24 is the step of stacking the plurality of the imprinted blank sheets 9 with the imprinted decorative border 8 into a first stack 50 of, preferably, 500 sheets.

In the following step 26, a cutting die 34 is provided. The die 34 is employed to die cut the gift-wrap papers 2 from the first stack 50 of the blank sheets 1 to form the ornamentally shaped gift-wrap papers 2. As illustrated in FIG. 4, the cutting die 34 includes a continuous cutting edge 36 defining a cavity 38 and welded onto a metal backing 39 to form an integral closed gang die with one open cutting end. A contour 37 of the continuous cutting edge 36 substantially corresponds to the continuous outer contour line 10 of the decorative border 8.

Preferably the cutting die used is a forged clearance die with a high polished finish and an extended cutting edge. The forged clear dies have a blade height of one and one quarter inches and cutting edge height of approximately one eighth of an inch. As those of skilled in the art of die cutting will readily recognize the cavity of the forged clearance die widens along the height of the blade.

Alternatively, flexible steel dies with a waxed finish can be used. The flexible steel die has a cavity of about one and one-quarter inches in height and a cutting edge height of thickness of about one sixteenth inch. Additionally, for either type of die breakaway chisel arms may be used to release pressure and allow thicker stacks of paper to be cut. It is also preferred to have pressure relief notches cut out of the top edge of the die to allow air to escape as the paper fills the die cavity.

It is important to keep dies sharp to maximize their cutting effectiveness. If too much force is applied to the dies, the edges of the stacks of tissue paper may fuse.

In the next step of the present method, the gift-wrap papers 2 are die cut from the first stack 50 of the blank sheets 1 to form a second stack of a plurality of the gift-wrap papers 2 (step 28). In order to achieve this, the cutting die 34 is placed onto the first stack 50 of the imprinted blank sheets 9 so that the cutting edge 36 thereof is substantially aligned with the outer contour line 11 of the decorative border 8 of the imprinted blank sheets 9, then a sufficient cutting force is applied to the cutting die 34 to cut the first stack 50 along the outer contour line 11 to form a second stack of the gift-wrap papers 2.

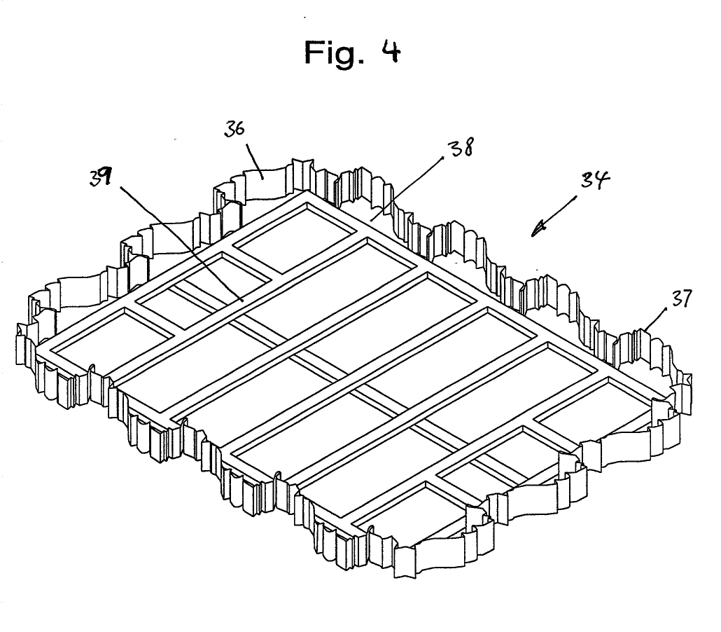

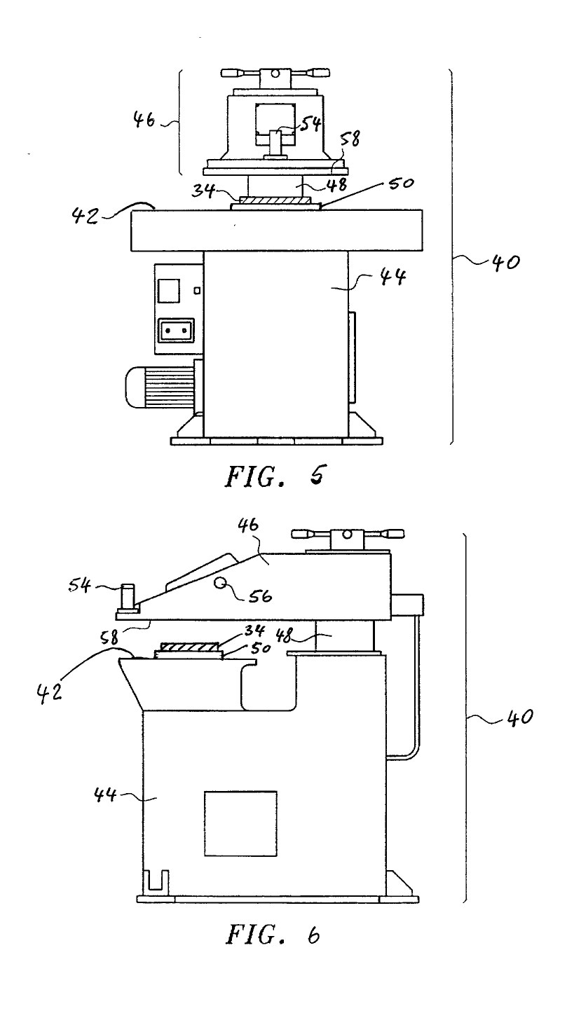

Preferably, a hydraulic cutting press is employed to apply the cutting force to the cutting die 34. An exemplary swing arm cutting press 40 is illustrated in FIGS. 5 and 6. This cutting press is an example of the type of cutting press used in the manufacturing of die cut gift-wrap paper in accordance with the present invention. Those skilled in the art will recognize that other appropriate die cutting machines can be used to practice the inventions described herein.

The cutting press 40 has a flat horizontal working area 42 supported by a base 44, and a moveable head 46 attached to the base 44 by an arm 48. The cutting press 40 is a standard hydraulic press that is well known to those skilled in the art and is adjustable so that various amounts of force can be applied to various types of and amount of material.

The first stack 50 of blank sheets 1 of the tissue paper is placed on a working area 42. The first stack 50 of the tissue paper may be of about 30 to 600 sheets, preferably 500 sheets.

Alternatively, the stack 50 may be metallized film of fifteen to three hundred sheets thick, preferably two hundred and fifty sheets thick for a single cavity die. In fact, as few as one sheet of tissue paper or metallized film can be cut by the disclosed method; however, for mass production of the gift-wrap papers, single sheet cutting is inefficient.

The hydraulic cutting press 1 depicted in FIGS. 5 and 6 is set to a specific setting to apply a sufficient amount of force to the die 34 which is placed on top of the tissue paper stack 50. The press 40 has the capacity to exert a proximal force of about 21 tons. The appropriate amount of pressure to be applied is proportional to the total linear inches of die cutting edges and the thickness of material to be cut. For three to five linear inches of cutting blade, one ton of pressure will cut one quarter inches of tissue paper.

The hydraulic cutting press 40 is activated by simultaneously pushing a center button 54 and one of two side buttons 56 which actuates the hydraulic press so that the hydraulic press head 46 is lowered towards the die 34 and the tissue stack 50. As the hydraulic press head 46 lowers, a plate 58 of the head 56 pushes down on the cutting die 34 causing the die 34 to cut the blank sheets 1 of the first tissue stack 50 forming a second stack of the gift-wrap papers 2 of the desired size and shape. The hydraulic press head 46 then raises up to allow an operator to remove the cutting die 34.

Finally, the second stack of the gift-wrap papers 2 is removed from the working area 42 and the gift-wrap papers 2 of the second stack are separated from each other (step 30).

Therefore, the method for making gift-wrap tissue paper in accordance with the present invention is a novel process provided for making a new aesthetically pleasing gift-wrap tissue paper having the decorative border and ornamental nonlinear outer contour line.

The foregoing description of the preferred embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A method for making gift-wrap paper, said method comprising the steps of:
(a) providing at least one blank sheet of a lightweight sheet material, said blank sheet having two opposite side surfaces;
(b) printing on at least one of said side surfaces of said blank sheet a continuous series of ornamental figures forming an imprinted blank sheet, said continuous series of ornamental figures defining a decorative border of said gift-wrap paper, said border having a continuous outer contour line formed by outer edges of said ornamental figures;
(c) providing a cutting die having a cavity defined by a continuous cutting edge, a contour of said cutting edge being substantially complimentary to at least portion of said outer contour line of said decorative border of said gift-wrap paper;
(d) placing said cutting die onto said imprinted blank sheet so that said cutting edge thereof is substantially aligned with said outer contour line of said decorative border of said gift-wrap paper;
(e) applying sufficient force to said die to cut said imprinted blank sheet along said outer contour line to form said gift-wrap paper; and
(f) separating said gift-wrap paper from said die.

2. The method for making gift-wrap paper as defined in claim 1, wherein said lightweight material is selected from the group comprising tissue paper, metallized film and vinyl film.

3. The method for making gift-wrap paper as defined in claim 1, wherein said continuous series of ornamental figures includes identical ornamental figures.

4. The method for making gift-wrap paper as defined in claim 1, wherein said continuous series of ornamental figures includes different ornamental figures.

5. The method for making gift-wrap paper as defined in claim 1, wherein said continuous series of ornamental figures are printed adjacent to side edges of said blank sheet.

6. The method for making gift-wrap paper as defined in claim 1, wherein the step (b) includes printing on both of said side surfaces of said blank sheet a continuous series of ornamental figures forming an imprinted blank sheet, said continuous series of ornamental figures defining a decorative border of said gift-wrap paper, said border having a continuous outer contour line formed by outer edges of said ornamental figures, said outer contour lines printed on said opposite sides of said blank sheet are aligned with respect to each other.

7. The method for making gift-wrap paper as defined in claim 1, wherein the step (b) is color printing.

8. The method for making gift-wrap paper as defined in claim 1, wherein said contour of said cutting edge being substantially complimentary to an entire length of said outer contour line of said decorative border of said gift-wrap paper.

9. The method for making gift-wrap paper as defined in claim 1, wherein said contour of said cutting edge being substantially complimentary to a portion of said outer contour line of said decorative border of said gift-wrap paper.

10. A method for making gift-wrap paper, said method comprising the steps of:
(a) providing a plurality of blank sheets of a lightweight sheet material, each of said blank sheets having two opposite side surfaces;
(b) printing on at least one of said side surfaces of said blank sheets a continuous series of ornamental figures forming a plurality of imprinted blank sheets, said continuous series of ornamental figures defining a decorative border of said gift-wrap paper, said decorative border having a continuous outer contour line formed by outer edges of said ornamental figures;
(c) stacking said plurality of imprinted blank sheets of lightweight sheet material into a first stack;
(d) providing a cutting die having a cavity defined by a continuous cutting edge, a contour of said cutting edge being substantially complimentary to at least a portion of said outer contour line of said decorative border;
(e) placing said cutting die onto said first stack so that said cutting edge thereof is substantially aligned with said outer contour line of said decorative border;
(f) applying sufficient force to said die to cut said first stack along said outer contour line to form a second stack of said gift-wrap papers; and
(g) separating said gift-wrap papers of said second stack from each other.

11. The method for making gift-wrap paper as defined in claim 10, wherein the step (b) includes printing on both of said side surfaces of each of said blank sheets a continuous series of ornamental figures forming decorative borders of said gift-wrap paper, said decorative borders having continuous outer contour lines formed by outer edges of said ornamental figures, said outer contour lines printed on said opposite sides of said blank sheets are aligned with respect to each other.

12. The method for making gift-wrap paper as defined in claim 10, wherein said lightweight material is selected from the group comprising tissue paper, metallized film and vinyl film.

13. The method for making gift-wrap paper as defined in claim 10, wherein said continuous series of ornamental FIGS. includes identical ornamental figures.

14. The method for making gift-wrap paper as defined in claim 10, wherein said continuous series of ornamental figures includes different ornamental figures.

15. The method for making gift-wrap paper as defined in claim 10, wherein said continuous series of ornamental figures are printed adjacent to side edges of said blank sheet.

16. The method for making gift-wrap paper as defined in claim 10, wherein said first stack includes approximately 500 of said imprinted blank sheets.

17. The method for making gift-wrap paper as defined in claim 10, wherein the step (b) is color printing.

18. The method for making gift-wrap paper as defined in claim 10, wherein said contour of said cutting edge being substantially complimentary to an entire length of said outer contour line of said decorative border of said gift-wrap paper.

19. The method for making gift-wrap paper as defined in claim 10, wherein said contour of said cutting edge being substantially complimentary to a portion of said outer contour line of said decorative border of said gift-wrap paper.

20. A gift-wrap paper comprising:
a sheet of lightweight material, said sheet having two opposite side surfaces and a continuous outer peripheral edge; and
a continuous series of ornamental figures imprinted on at least one of said side surfaces of said sheet and forming a decorative border of said gift-wrap paper, wherein an outer contour line of said decorative border formed by outer edges of said ornamental figures substantially corresponds to at least a portion of said continuous outer peripheral edge.

21. The gift-wrap paper as defined in claim 20, wherein said continuous series of ornamental figures are imprinted on both of said side surfaces of said gift-wrap paper.

22. The gift-wrap paper as defined in claim 20, wherein said ornamental figures are imprinted in color.

23. The gift-wrap paper as defined in claim 20, wherein said lightweight material is selected from the group comprising tissue paper, metallized film and vinyl film.

24. The gift-wrap paper as defined in claim 20, wherein said continuous series of ornamental figures includes identical ornamental figures.

25. The gift-wrap paper as defined in claim 20, wherein said continuous series of ornamental figures includes different ornamental figures.

26. The gift-wrap paper as defined in claim 20, wherein said outer contour line of said decorative border substantially corresponds to an entire length of said continuous outer peripheral edge.

27. The gift-wrap paper as defined in claim 20, wherein said outer contour line of said decorative border substantially corresponds to a portion of said continuous outer peripheral edge.
